(19) United States
(12) Patent Application Publication
(10) Pub. No.: US 2006/0133225 A1
(43) Pub. Date: Jun. 22, 2006

(54) Method and device for setting sequence of playing disks in optical disk drives

(76) Inventor: Jui-Chiang Lin, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/251,812

(22) Filed: Oct. 18, 2005

(30) Foreign Application Priority Data
Dec. 17, 2004 (TW) 093139519

(51) Int. Cl. G11B 17/22

(52) U.S. Cl. 369/30.3

(57) ABSTRACT

A method and device for setting the sequence of playing disks of an optical disk drive includes an input unit for resetting the sequence of playing disks and the input unit is connected to a CPU. When the sequence of loading of disk is wrong, the user may input a resetting signal via the input unit so as to move the pickup head to the last layer of disk of the magazine and to reset to the reverse playing sequence. By this way, the user plays the disks by the correct sequence without reloading the disks one by one.

### FIELD OF THE INVENTION

The present invention relates to a method and device for setting sequence of playing disks in an optical disk drive, especially for a simple input command to automatically change the sequence of playing of the disks such that the users need not to re-load the disks to increase the flexibility of convenience of use.

### BACKGROUND OF THE INVENTION

There are many designs of conventional mechanisms for changing disks in an optical disk drive and the present invention is provided to improve the disk changing mechanism as disclosed in FIG. 6 to change the sequence of playing of the disks by an easy way so as to avoid reloading all the disks.

The applicant has searched related references of prior art such as U.S. Pat. No. 5,848,033 which discloses a method for searching an identification of a disk mounting section selectively reproduces a desired disk in an optical disk drive system, and U.S. Pat. No. 5,671,196 which discloses a method for controlling a rotatable optical disk storing magazine. Nevertheless, what the references of prior art disclose are different from the method and optical disk drive of the present invention.

As disclosed in FIGS. 6 and 7, the conventional optical disk drive 10 includes a base 100 with a core 30 and a magazine 20 connected thereon. A plurality of trays 21 are installed in the magazine 20 and each tray 21 supports an optical disk. The core 30 includes a pulling mechanism 31, a pickup head 34, a moving mechanism 33 and a rotating mechanism which is not shown and hidden by the core 30. The user puts the optical disks into the magazine in a desired sequence and when the conventional optical disk drive is activated, the pulling mechanism 31 pulls the first layer of disk 40 from the magazine 20 and the rotating mechanism rotates the disk 40 so that the pickup head 34 reads the disk 40. After the first layer of disk 40 is completely played, the pulling mechanism 31 moves the disk back to its original position and the moving mechanism 33 moves the core 30 to a corresponded position where the second layer of disk 41 is located. The same processes as to the first layer of disk are proceeded to play the second layer of disk 41 and each layer of disk until the last layer of disk 42 is played. However, if the sequence of the disks is wrongly installed, the user has to take all the disks out from the magazine and reload the disks again in desired sequence. This is because the conventional optical disk drive does not have a function to re-set the sequence of playing of the disks.

### SUMMARY OF THE INVENTION

The main object of the present invention is to provide a simple method to change the reading sequence of the pickup head to improve the flexibility of use of the optical disk drive. The method provides an input unit for resetting the sequence of playing the disk. When the disk magazine is input the input unit or the power of the disk drive is activated, the predetermined playing sequence logic mode is loaded and the magazine that the optical heading head is located is set to be the first layer of disk. The disks are then played by the sequence from the first layer of disk to the last layer of disk. When a reset signal of re-setting the sequence is received, the playing is stopped and all the disks are back to the magazine. The optical pickup head is moved to the last layer of disk and the playing sequence logic mode is set to play the disks from the last layer of disk to the first layer of disk and back to the step of loading the logic mode of sequence of playing the disks.

Another object of the present invention is to provide a method and device for achieving the main object. The device includes a CPU on the optical disk drive, an up-down controller connected to the CPU, an pulling mechanism controller connected to the CPU, a rotating mechanism controller connected to the CPU, and a reset input unit connected to the CPU for resetting the sequence of playing the disks. When the user presses the input unit, the pickup head is moved to the last layer of disk and the playing sequence logic mode is reset and the sequence is rest to be reverse to the previous sequence.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view of the optical disk drive of the present invention;

FIG. 2 shows the arrangement of the optical disk drive of the present invention;

FIG. 3 is a flow chart of the method of the present invention;

FIG. 4 shows the pickup head and the magazine before the wrong sequence is reset;

FIG. 5 shows that the position of the pickup head is moved to correct position after the sequence is reset;

FIG. 6 is a conventional optical disk drive, and

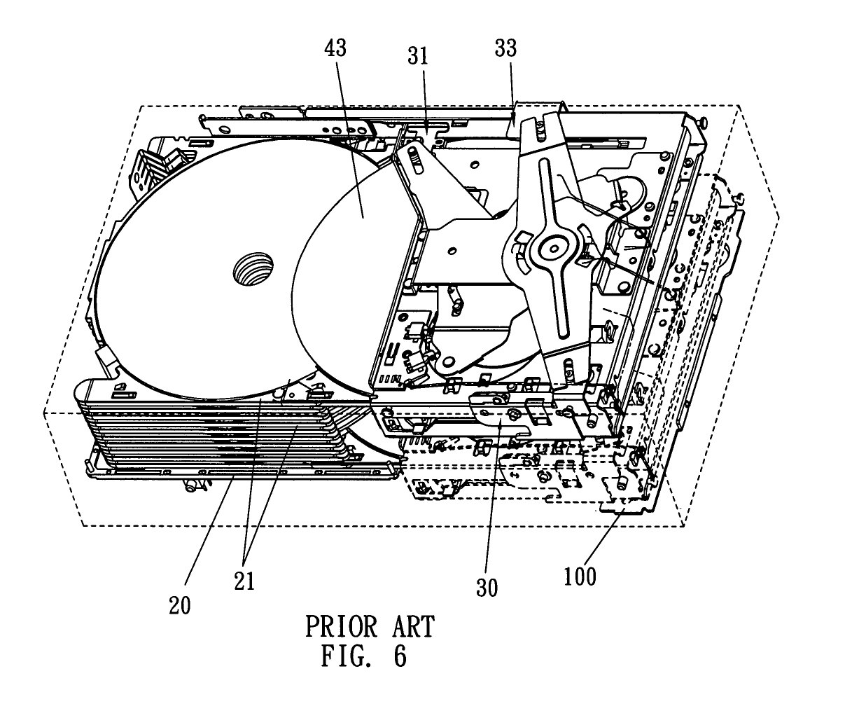

FIG. 7 shows the pickup head is located at a wrong position relative to the magazine of the conventional optical disk drive.

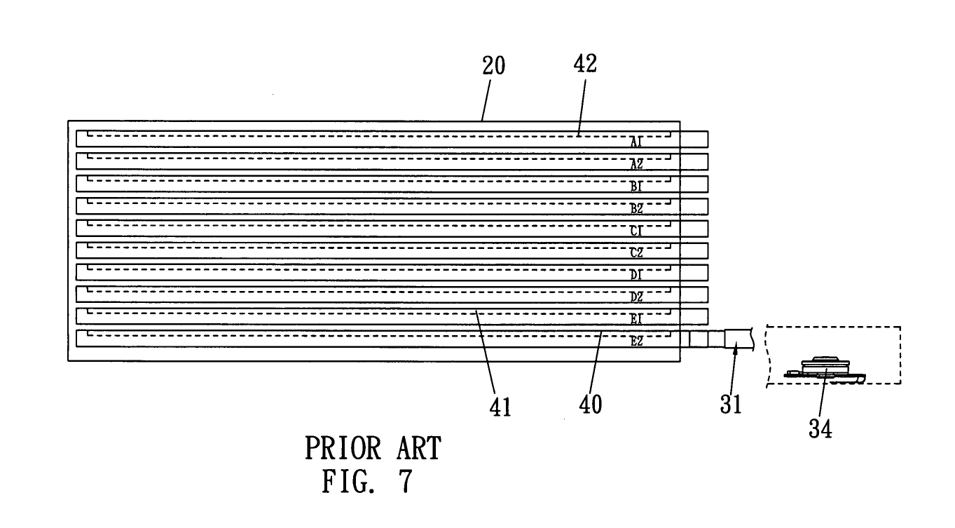

### DETAILED DESCRIPTION OF THE PREFERRED EMBODIMENT

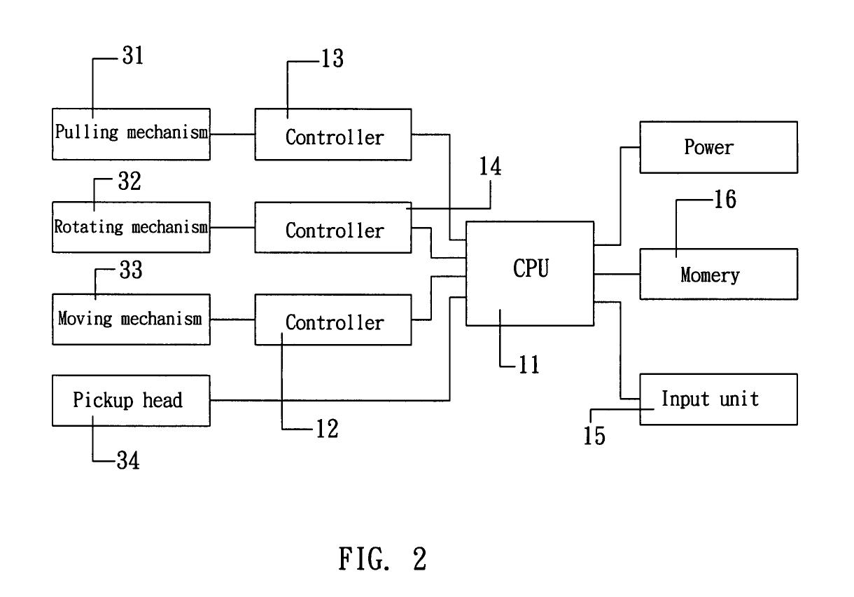

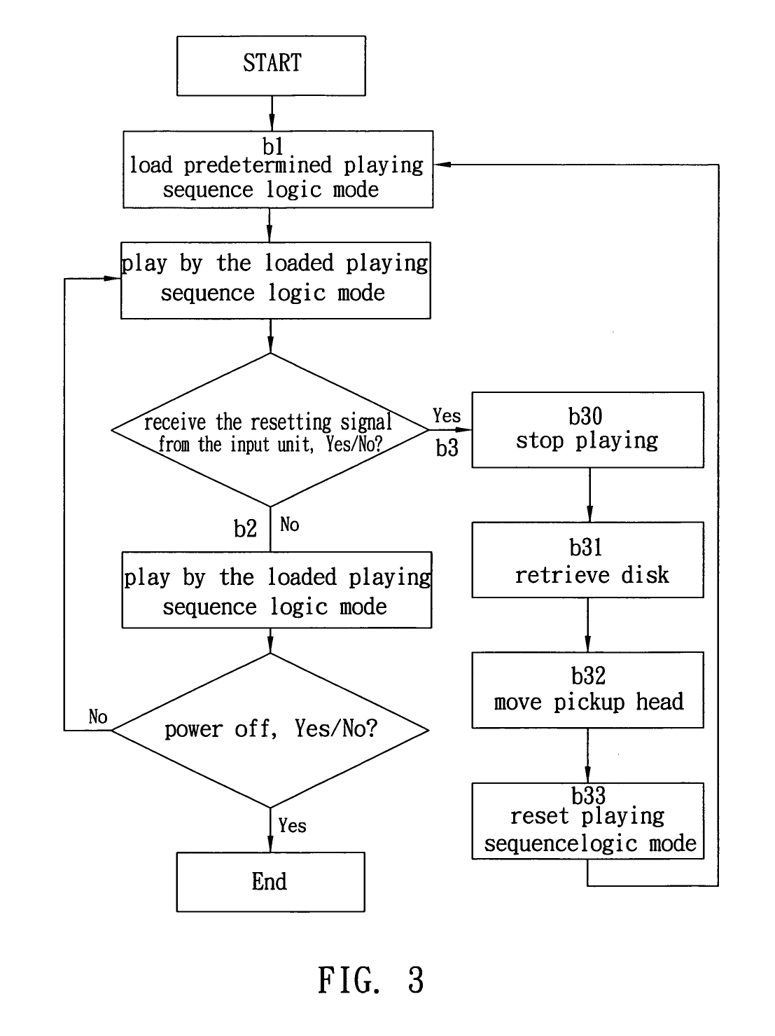

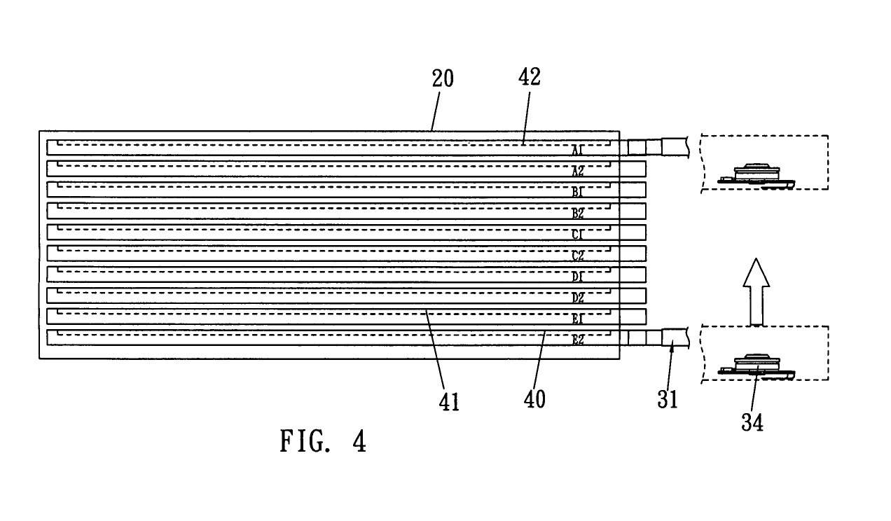

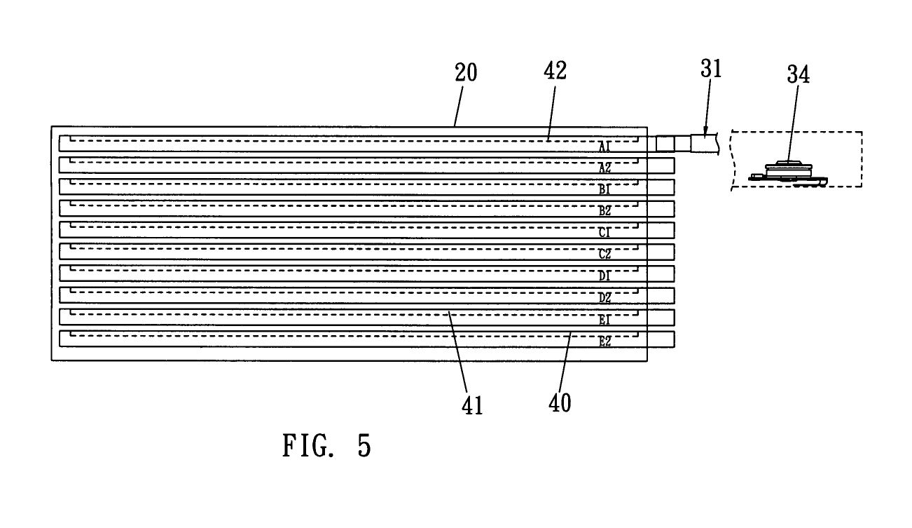

Referring to FIGS. 2 to 5, the method for resetting the sequence of playing disks of an optical disk drive of the present invention comprises the following steps:

(A) providing an input unit 15 for resetting the sequence of playing disks;

(B) proceeding the following steps after the magazine 20 is loaded in the optical disk drive or after the power of the optical disk drive is on:
(b1) loading the predetermined playing sequence logic mode, the disks are played by the sequence from the first layer of disk 40 to the last layer of disk 42 according to the predetermined playing sequence login mode;
(b2) the disks being played by the loaded sequence till the power is turn off if the signal outputting from the input unit 15 for resetting the sequence of playing disks is not received;
(b3) when receiving the signal outputting from the input unit 15 for resetting the sequence of playing disks, the following steps are proceeded:
   (b30) stopping the playing of the disks;
   (b31) retrieving the disks in the magazine 20;
   (b32) moving the pickup head 34 to a location corresponded to the last layer of disk 43 of the magazine 20; and
   (b33) setting the playing sequence logic mode to reverse playing the disk, i.e. playing from the last layer of disk 42 to the first layer of disk 40, and going back to step (b1).

A preferred embodiment of the present invention provides a storing area for storing the playing sequence logic mode. Wherein, the storing area can be provided by one memory or more. Whenever the magazine is loaded or the power of the optical disk drive is on, the optical disk drive plays the disk by the sequence stored in the storing area.

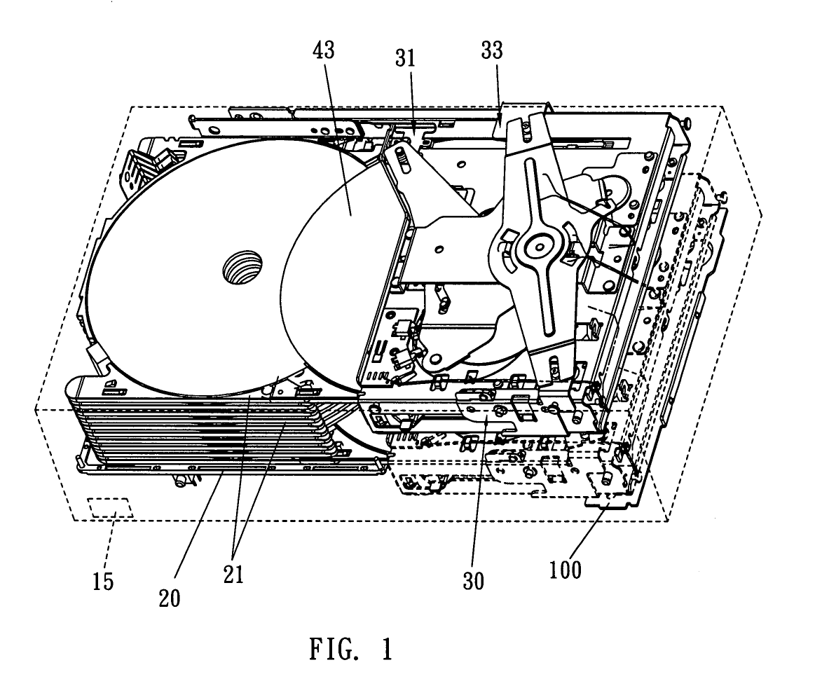

As disclosed in FIGS. 1-5, the optical disk drive 10 includes a base 100 with a magazine 20 and a core 30 connected thereto. The magazine 20 includes a plurality of trays 21 installed thereto and each tray 21 supports an optical disk. The core 30 includes a pulling mechanism 31, a rotating mechanism 32, a moving mechanism 33, and a pickup head 34. The core 30 is moveable related to the magazine 20 and the pulling mechanism 31 is able to located corresponding to every tray 21 in the magazine 20 during the movement of the core 30 so as to draw out the tray. When the magazine 20 is loaded in the optical disk drive or the power of the optical disk drive is on, the following steps are proceeded:
(b1) When the playing sequence logic mode is loaded, the pulling mechanism 31 draws the first layer of disk 40 from the magazine 20 and the rotating mechanism 32 rotates the disk 40. Thereafter the first layer of disk 40 is played by the pickup head 34. When the first layer of disk 40 is played completely, the disk 40 is pushed back to the first layer of disk 40 and the core 30 is moved to a location corresponded to the second layer of disk 41 by the moving mechanism 33. The second layer of disk 41 and the other layer of disks are played by the same control actions as described above. The disks are played in sequence layer by layer until the last layer of disk 42 is played completely.
(b2) The disks are played by the loaded sequence till the power is turn off if the signal from the input unit 15 for resetting the sequence of playing disks is not received;
(b3) When the signal from the input unit 15 for resetting the sequence of playing disks is received, the following steps are taken:
   (b30) stopping the playing of the disks;
   (b31) retrieving the disks in the magazine 20 by the pulling mechanism 31;
   (b32) moving the pickup head 34 to the last layer of disk 43 of the magazine 20 by the moving mechanism 33; and
   (b33) setting the logic mode of sequence for reverse playing the disks, i.e. playing the disk from the last layer of disk 42 to the first layer of disk 40, and going back to step (b1).

As shown in FIGS. 1 and 2, the control device for resetting the playing sequence of the disks includes a CPU 11 on the optical disk drive 10, an up-down controller 12 connected to the CPU 11, an pulling mechanism controller 13 connected to the CPU 11, a rotating mechanism controller 14 connected to the CPU 11, and a reset input unit 15 connected to the CPU 11 for resetting the sequence of playing the disks.

The reset input unit 15 for resetting the sequence of playing the disks is an input button and preferably, the input button is located on the optical disk drive 10.

A preferable embodiment of the present invention further comprises a memory 16 for storing the playing sequence logic modes for playing disks.

By the function of resetting the sequence of playing the disks, users are not restricted to load the disks at a certain sequence one by one, when the sequence of loading is wrong, a new reset signal is input by the input unit 15 or even press the reset button on the optical disk drive, the sequence of playing is amended to desired sequence.

While we have shown and described the embodiment in accordance with the present invention, it should be clear to those skilled in the art that further embodiments may be made without departing from the scope of the present invention.

What is claimed is:

1. A method for setting sequence of playing disks, comprising the following steps:
(A) providing an input unit for resetting the sequence of playing disks;
(B) proceeding the following steps after the magazine is loaded in the optical disk drive or after the power of the optical disk drive is on:
(b1) loading a predetermined playing sequence logic mode and the disks are played by the sequence according to the predetermined playing sequence logic mode;
(b2) the disks being played by the predetermined playing sequence mode till the power is turn off if the signal from the input unit 15 for resetting the sequence of playing disks is not received;
(b3) when receiving the signal from the input unit 15 for resetting the sequence of playing disks, the following steps are taken:
(b30) stopping the playing of the disks;
(b31) retrieving the disks in the magazine 20;
(b32) moving the pickup head 34 to a location corresponded to the last layer of disk 43 of the magazine 20; and
(b33) setting the playing sequence logic mode to playing the disk from the last layer of disk 42 to the first layer of disk 40, and going back to step (b1).

2. The method as claimed in claim 1, wherein a storing area is provided to receive the playing sequence logic modes, the optical disk drive plays the disks according to the sequence stored in the storing area when the magazine is loaded in the optical disk drive or the power of the optical disk drive is on.

3. The method as claimed in claim 1, wherein the optical disk drive includes a base with a magazine and a core connected thereto, the magazine includes a plurality of trays installed thereto and each tray supports an optical disk, the core includes an pulling mechanism, a rotating mechanism, a moving mechanism, and a pickup head, the core is moveable related to the magazine and the pulling mechanism is located corresponding to every tray in the magazine during the movement of the core so as to draw the disk, when the magazine is loaded in the optical disk drive or the power of the optical disk drive is on, the following steps are proceeded:
(b1) loading the playing sequence logic mode, the pulling mechanism drawing the first layer of disk from the magazine and the rotating mechanism rotating the disk, thereafter the first layer of disk is played by the pickup head, if the first layer of disk played completely, the disk being pushed back to the magazine and the core being moved to a location corresponded to the second layer of disk by the moving mechanism, the second layer and the other layer of disks are played by the same control actions as described above, the disks being played in sequence layer by layer until the last layer of disk is played completely;
(b2) the disks being played by the loaded sequence till the power is turn off if the signal of the input unit for resetting the sequence of playing disks is not received;
(b3) when the signal from the input unit for resetting the sequence of playing disks is received, the following steps are taken:
(b30) stopping the playing of the disks;
(b31) retrieving the disks in the magazine by the pulling mechanism;
(b32) moving the pickup head to the last layer of disk of the magazine by the moving mechanism; and
(b33) setting the playing sequence logic mode to play the disk from the last layer of disk to the first layer of disk, and going back to step (b1).

4. A control device for resetting sequence of playing disks of a multi-tray optical disk drive, comprising:
a CPU on the optical disk drive, an up-down controller connected to the CPU, an pulling mechanism controller connected to the CPU, a rotating mechanism controller connected to the CPU, and a reset input unit connected to the CPU for resetting the sequence of playing the disks, wherein the CPU controls the up-down controller, the pulling mechanism controller and the rotating mechanism controller to make a reverse playing sequence of playing disks when a resetting signal is outputted from the said reset input unit.

5. The mechanism as claimed in claim 4, wherein the reset input unit is an input button.

6. The mechanism as claimed in claim 4, wherein the reset input unit is an input button which is located on the optical disk drive.

7. The mechanism as claimed in claim 4 further comprising a memory for receiving logic modes of sequences of playing the disks.

8. A method for setting sequence of playing disks of an optical disk drive, comprising the following steps:
reading a first playing sequence logic mode in a storing area to decide the sequence of playing the disks of the optical disk drive; and
when a resetting signal for resetting the sequence of playing the disks from an input unit is received, the optical disk drive plays the disks according to a second playing sequence logic mode.

9. The method as claimed in claim 8, wherein the reset input unit is an input button.

10. The method as claimed in claim 8, wherein the first playing sequence logic mode plays the disks by the sequence of a first layer of disk of the magazine to the last layer of disk of the magazine.

11. The method as claimed in claim 8, wherein the second playing sequence logic mode plays the disks by the sequence of a last layer of disk of the magazine to the disk in the first layer of disk of the magazine.

12. The method as claimed in claim 8, wherein the storing area includes at least one memory.
